(19) United States
(12) Patent Application Publication
(10) Pub. No.: US 2018/0271727 A1
(43) Pub. Date: Sep. 27, 2018

(54) LIFT CHAIR AND METHOD FOR LIFTING A SEAT THEREOF

(71) Applicant: Zero One Design Inc., Taipei City (TW)

(72) Inventors: Cheng-Huang LEE, Taipei City (TW); Fan-Chen KAO, Taipei City (TW)

(21) Appl. No.: 15/464,593

(22) Filed: Mar. 21, 2017

(51) Int. Cl. A61G 5/14; A47C 7/56; A47C 7/54; A47C 7/40

(52) U.S. Cl. CPC A61G 5/14; A47C 7/40; A47C 7/54; A47C 7/56

(57) ABSTRACT

A lift chair is provided, including a base, a seat, and a driving mechanism connected to the base and the seat. The driving mechanism can drive the seat to move relative to the base between a first position and a second position. When the seat is in the first position, a first distance is formed between the seat and the base. When the seat is in the second position, a second distance exceeding the first distance is formed between the seat and the base. When the seat is in the second position, the driving mechanism can drive the seat to rotate relative to the base.

### BACKGROUND OF THE INVENTION

### Field of the Invention

The application relates in general to a lift chair, and in particular, to a lift chair having a driving mechanism.

### Description of the Related Art

Various lift chairs are available which have been developed principally to assist the elderly and handicapped in moving into a standing position from a seated position.

However, even when a conventional lift chair is able to rotate, the user in the lift chair should exert force on the calves and the knees to stand up. As a result, an injury may be caused to the calves or knees.

### BRIEF SUMMARY OF INVENTION

To address the deficiencies of the conventional lift chair, an embodiment of the invention provides a lift chair, including a base, a seat, and a driving mechanism connected to the base and the seat. The driving mechanism can drive the seat to move relative to the base between a first position and a second position. When the seat is in the first position, a first distance is formed between the seat and the base. When the seat is in the second position, a second distance exceeding the first distance is formed between the seat and the base. When the seat is in the second position, the driving mechanism can drive the seat to rotate relative to the base.

In some embodiments, during the movement of the seat between the first position and the second position, the top surface of the seat remains horizontal.

In some embodiments, the seat is in the first position, a height is formed between the top surface of the seat and the bottom of the base, wherein the distance between the first position and the second position is ⅕-⅙ of the height.

In some embodiments, the distance between the first position and the second position is 5 cm-10 cm.

In some embodiments, the driving mechanism comprises a first fixing member affixed to the base, a first guiding slot formed on the first fixing member, a second fixing member affixed to the seat, a second guiding slot formed on the second fixing member, a first rod connected to the first fixing member and the second fixing member, and a second rod connected to the first fixing member and the second fixing member. One end of the first rod is slidably disposed in the second guiding slot, and another end of the first rod is pivotally connected to the first fixing member. One end of the second rod is slidably disposed in the first guiding slot, and another end of the second rod is pivotally connected to the second fixing member.

In some embodiments, the first rod and the second rod form an X-shaped structure.

In some embodiments, the second guiding slot has a longitudinal structure, and the first guiding slot has a parallel portion and an inclined portion, wherein an obtuse angle is formed between the parallel portion and the inclined portion.

In some embodiments, the parallel portion has a first side communicated with the inclined portion and a second side opposite to the first side, wherein when the end of the second rod is situated at the second side, the seat is in the first portion, wherein when the end of the second rod is situated at the first side, the seat is in the second position.

In some embodiments, when the end of the second rod slides along the inclined portion, the seat rotates relative to the base.

In some embodiments, the first rod is pivotally connected to the second rod.

In some embodiments, the driving mechanism further comprises a first motor connected to the first rod and the second rod.

In some embodiments, the driving mechanism further comprises a second motor connected to the second fixing member.

In some embodiments, the driving mechanism comprises a first fixing member affixed to the base, a second fixing member affixed to the seat, a first motor, a telescopic rod connected to the first motor and the second fixing member, and a second motor connected to the second fixing member.

An embodiment of the invention further provides a method for lifting the seat of a lift chair, including moving the seat from a first position to a second position, wherein when the seat is in the first position, a first distance is formed between the seat and the base, and when the seat is in the second position, a second distance exceeding the first distance is formed between the seat and the base; and rotating the seat relative to the base when the seat is in the second position.

In some embodiments, when the seat moves from the first position to the second position, the top surface of the seat remains horizontal.

In some embodiments, when the seat is in the first position, a height is formed between the top surface of the seat and the bottom of the base, wherein the distance between the first position and the second position is ⅕-⅙ of the height.

In some embodiments, the distance between the first position and the second position is 5 cm-10 cm.

In some embodiments, the rotation angle of the seat is 15 degrees-45 degrees.

### BRIEF DESCRIPTION OF DRAWINGS

The invention can be more fully understood by reading the subsequent detailed description and examples with references made to the accompanying drawings, wherein:

FIG. 1A is a schematic diagram of a lift chair according to an embodiment of the invention;

FIG. 1B is an exploded-view diagram of a lift chair according to an embodiment of the invention;

FIG. 2A is a schematic diagram of a driving mechanism according to an embodiment of the invention;

FIG. 2B is an exploded-view diagram of a driving mechanism according to an embodiment of the invention;

FIG. 2C is a cross-sectional view taken along line A-A in FIG. 2A;

FIG. 3A is a cross-sectional view of a lift chair when the seat is in the first position according to an embodiment of the invention;

FIG. 3B is a cross-sectional view of a driving mechanism when the seat is in the first position according to an embodiment of the invention;

FIG. 4A is a cross-sectional view of a lift chair when the seat is in the second position according to an embodiment of the invention;

FIG. 4B is a cross-sectional view of a driving mechanism when the seat is in the second position according to an embodiment of the invention;

FIG. 5A is a cross-sectional view of a lift chair when the seat rotates relative to the base according to an embodiment of the invention;

FIG. 5B is a cross-sectional view of a driving mechanism when the seat rotates relative to the base according to an embodiment of the invention;

FIG. 6 is a schematic diagram of a driving mechanism according to another embodiment of the invention;

FIG. 7 is a schematic diagram of a driving mechanism according to another embodiment of the invention;

FIG. 8A is a schematic diagram of a driving mechanism when the seat is in the second position according to another embodiment of the invention; and

FIG. 8B is a schematic diagram of a driving mechanism when the seat rotates relative to the base according to an embodiment of the invention.

### DETAILED DESCRIPTION OF INVENTION

The making and using of the embodiments of the lift chair is discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood to one of ordinary skill in the art to which this invention belongs. It should be appreciated that each term, which is defined in a commonly used dictionary, should be interpreted as having a meaning conforming to the relative skills and the background or the context of the present disclosure, and should not be interpreted by an idealized or overly formal manner unless defined otherwise.

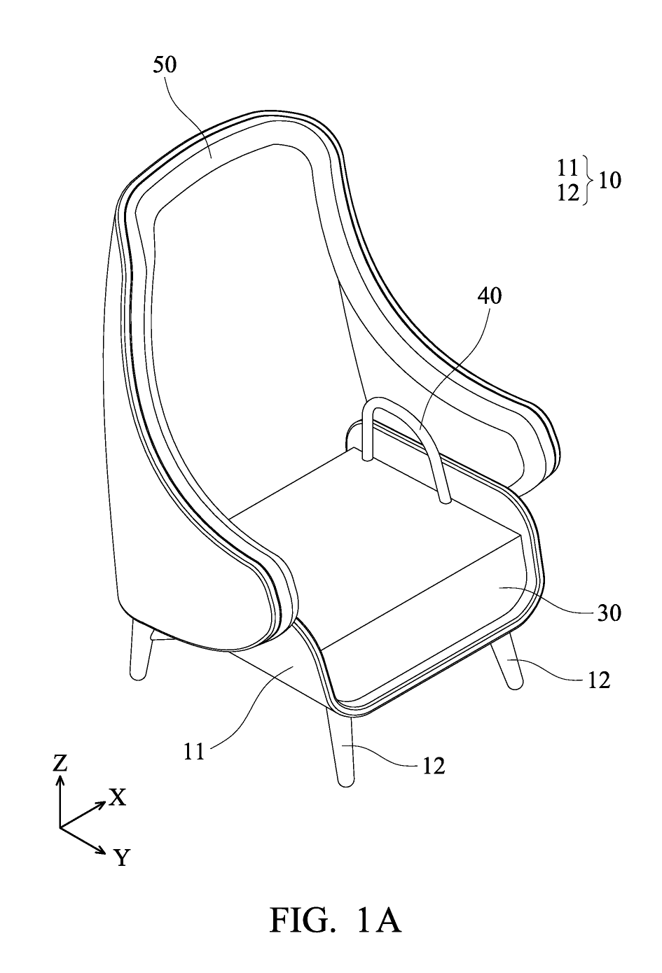

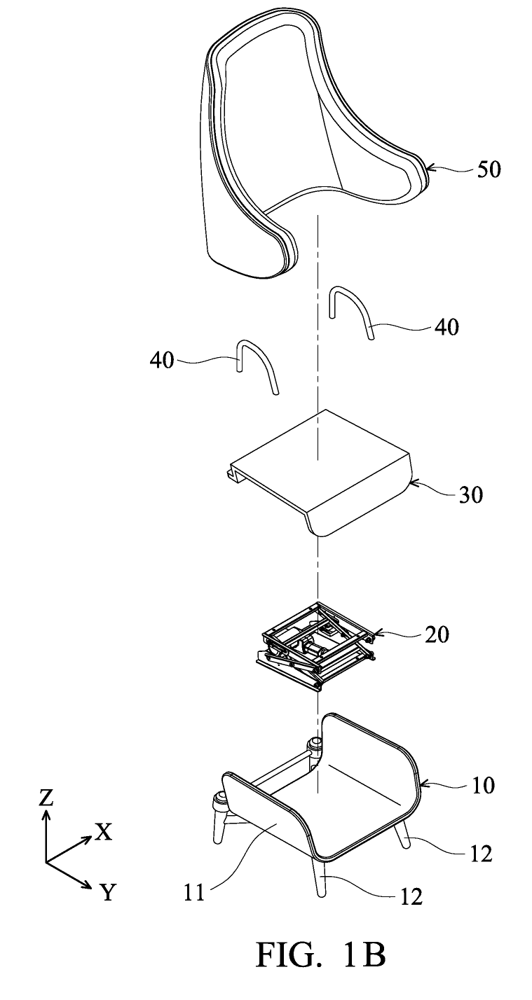

Referring to FIGS. 1A and 1B, a lift chair according to an embodiment of the invention primarily comprises a base 10, a driving mechanism 20, a seat 30, a plurality of armrests 40, and a back 50. The base 10 has a U-shaped member 11 and a plurality of supports 12 connected to the U-shaped member 11. The driving mechanism 20 is affixed to the U-shaped member 11 and disposed between the base 10 and the seat 30. The armrests 40 are affixed to the seat 30, and the back 50 is pivotally connected to the base 10.

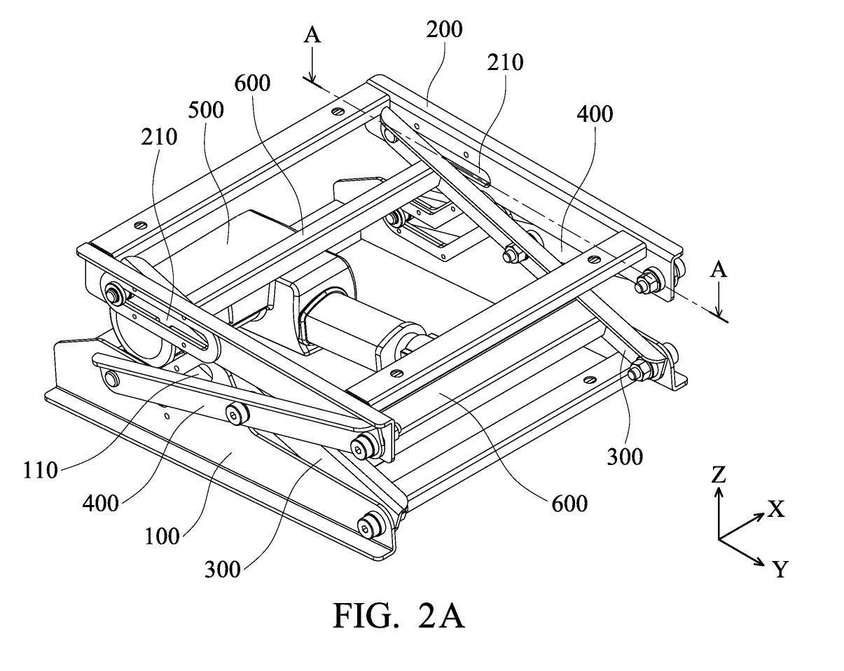

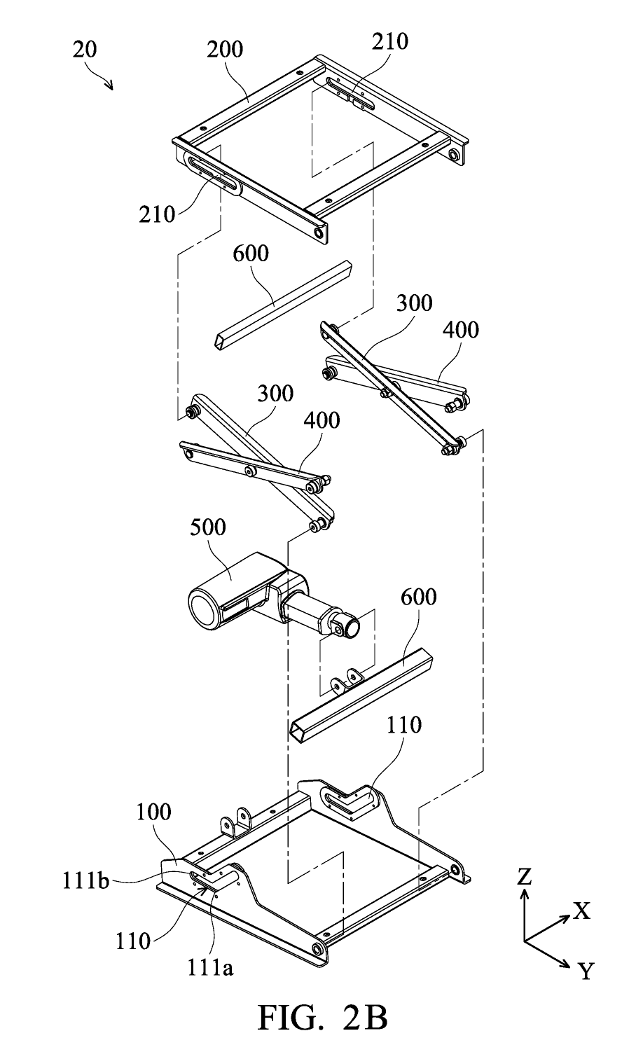

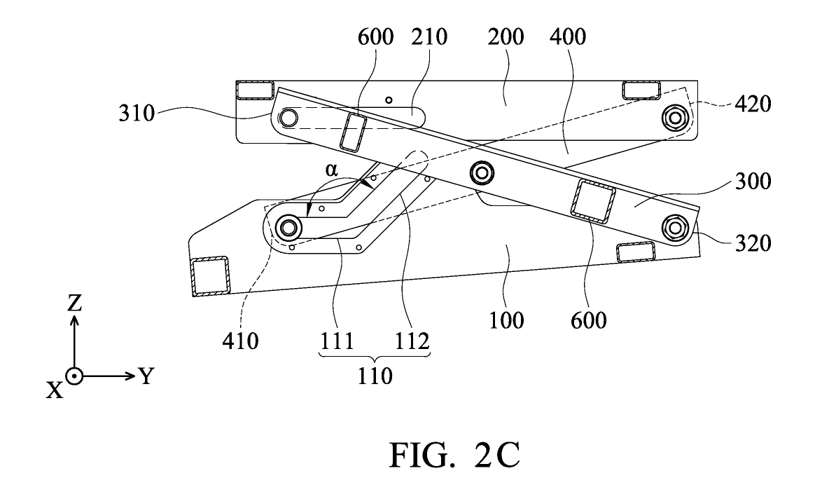

As shown in FIGS. 2A-2C, in this embodiment, the aforementioned driving mechanism 20 comprises a first fixing member 100, a second fixing member 200, at least one first rod 300, at least one second rod 400, a first motor 500, and a plurality of connecting members 600.

The first fixing member 100 is affixed to the base 10 and at least one first guiding slot 110 is formed on the first fixing member 100, wherein the first guiding slot 110 extends along the Y-axis. In other words, the first guiding slot 110 extends from the rear side of the base 10 (the side connected to the back 20) toward the front side of the base 10. The first guiding slot 110 comprises a parallel portion 111 and an inclined portion 112 communicated with the parallel portion 111. Specifically, the parallel portion 111 has a first side 111a and a second side 111b, wherein the first side 111a is communicated with the inclined portion 112, and the second side 111b is opposite to the first side 111a. The inclined portion 112 extends from the first side 111a of the parallel portion 111 toward the second fixing member 200, therefore, an obtuse angle α is formed between the parallel portion 111 and the inclined portion 112, and the distance between the second fixing member 200 and the inclined portion 112 is less than that between the second fixing member 200 and the parallel portion 111.

The second fixing member 200 is affixed to the seat 30 and at least one second guiding slot 210 is formed on the second fixing member 200. Similarly, the second guiding slot 210 extends from the rear side of the base 10 (the side connected to the back 20) toward the front side thereof. Both the first guiding slot 110 and the second guiding slot 210 are adjacent to the rear side of the base 10, however, the appearance of the second guiding slot 210 is different from that of the first guiding slot 110. In this embodiment, the second guiding slot 210 has a longitudinal structure.

As shown in FIG. 2C, the first rod 300 is connected to the first fixing member 100 and the second fixing member 200. One end 310 of the first rod 300 is slidably disposed in the second guiding slot 210 of the second fixed member 200, and the other end 320 of the first rod 300 is pivotally connected to the first fixed member 100. The second rod 400 is connected to the first fixing member 100 and the second fixing member 200. One end 410 of the second rod 400 is slidably disposed in the first guiding slot 110 of the first fixed member 100, and the other end 420 of the second rod 400 is pivotally connected to the second fixed member 200.

In this embodiment, the first rod 300 and the second rod 400 form an X-shaped structure, and are pivotally connected to each other. The first rod 300 and/or the second rod 400 are connected to the connecting members 600. The first motor 500 can push or pull the connecting members 600 to supply force to the first rod 300 and/or the second rod 400, and the first rod 300 and the second rod 400 can move relative to the first fixing member 100/the second fixed member 200.

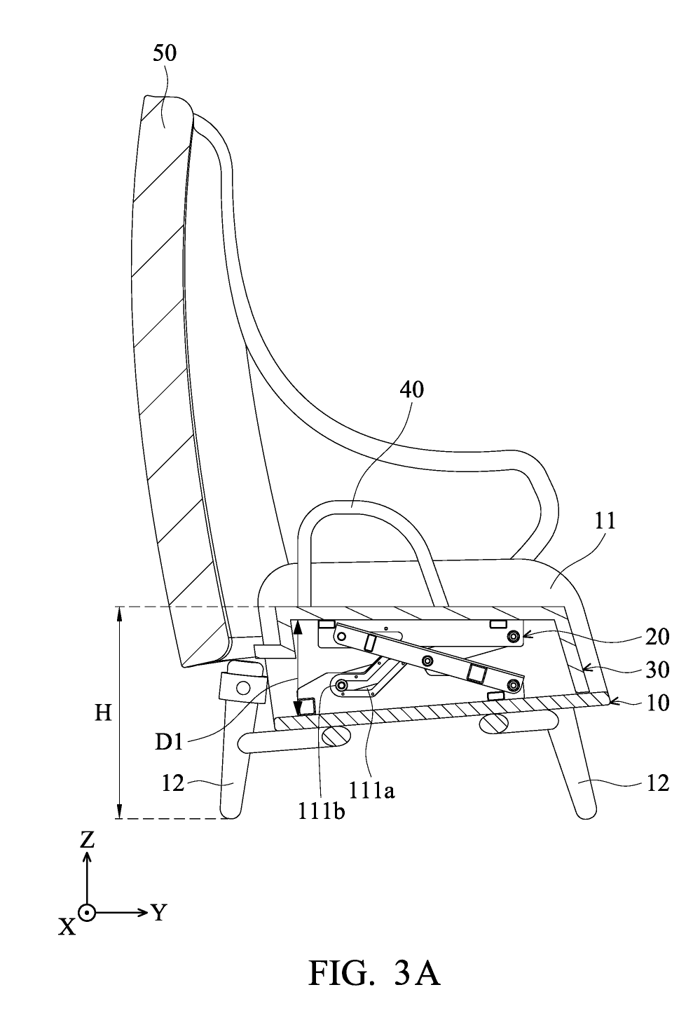

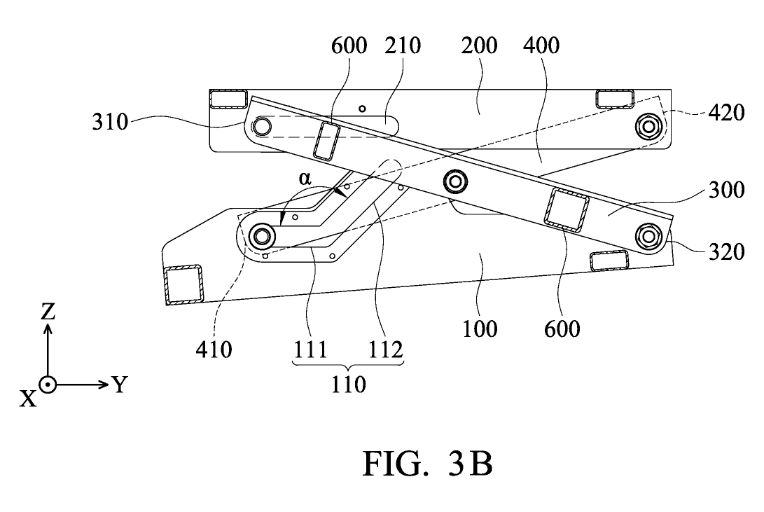

Referring to FIGS. 3A and 3B, when the end 410 of the second rod 400 is situated at the second side 111b of the parallel portion 111, the seat 30 is in a first position relative to the base 10. Here, a height H is formed between the top surface of the seat 30 and the bottom of the base 10, and the top surface of the seat 30 is horizontal. The height H is similar to the length of the calf of a human, such as 37 cm-45 cm. Therefore, the user can sit on the lift chair steadily.

When the seat 30 is in the first position, a first distance D1 is formed between the seat 30 and the base 10, and the seat 300 can cover the driving mechanism 20. The exposure of the driving mechanism 20 can be avoided.

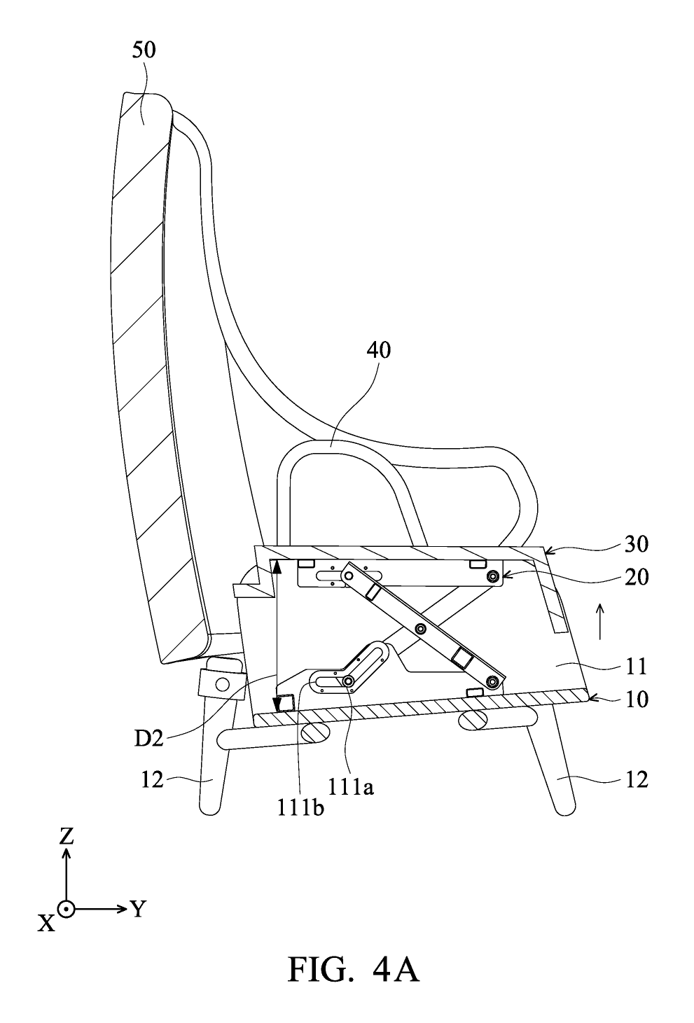

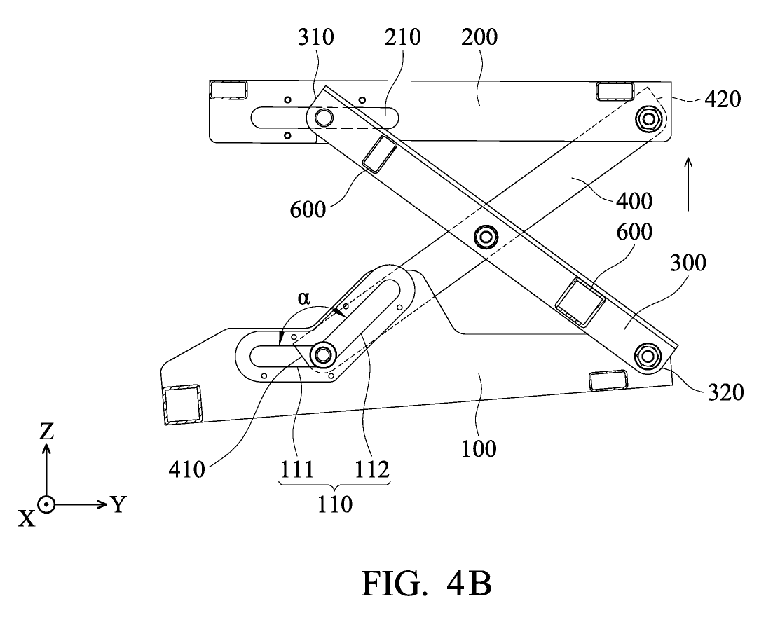

When the user wants to leave the lift chair, the lift chair can assist the user to stand up. As shown in FIGS. 4A and 4B, first, the first motor 500 can exert a force on the connecting member 600 to move the end 410 of the second rod 400 along the parallel portion 111 from the second side 111b to the first side 111a, and move the end 310 of the first rod 300 along the second guiding slot 200. When the end 410 of the second rod 400 moves from the second side 111b to the first side 111a, the second fixing member 200 and the seat 30 move upward, wherein the seat 30 can move from the first position to the second position.

In this embodiment, when the end 410 of the second rod 400 moves from the second side 111b to the first side 111a, the second fixed member 200 moves along a direction perpendicular to the ground. Namely, during the movement of the seat 30 between the first position and the second position, the top surface of the seat 30 remains horizontal.

When the seat 30 is in the second position, a second distance D2 is formed between the seat 30 and the base 10, wherein D2>D1. The distance between the first position and the second position can be 5 cm-10 cm. In other words, the distance between the first position and the second position is ⅕-⅙ of the height H.

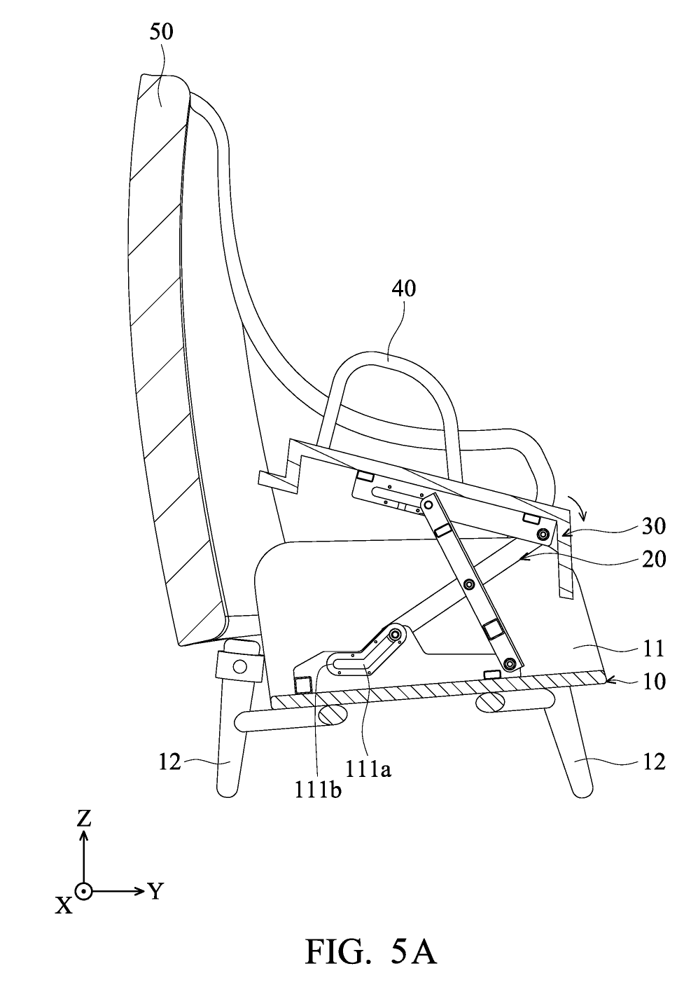

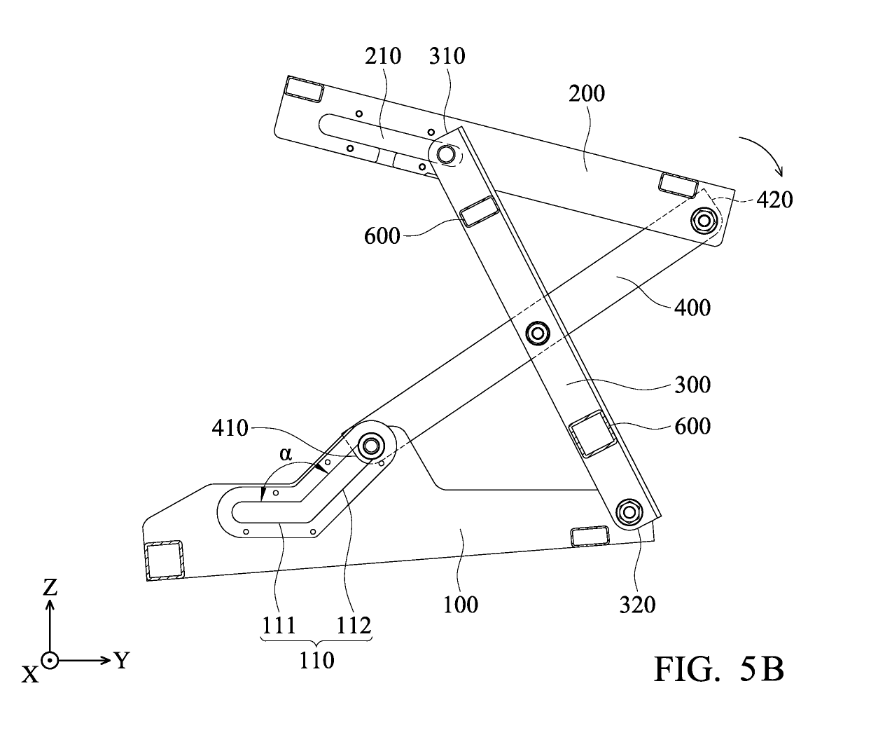

As shown in FIGS. 5A and 5B, when the end 410 of the second rod 400 is situated at the first side 111 and the seat 30 is in the second position, the first motor 500 can continually provide a force on the connecting member 600 to move the end 410 of the second rod 400 along the inclined portion 112 of the first guiding slot 110. When the end 410 of the second rod 400 slides along the inclined portion 112, the second fixing member 200 and the seat 30 rotates relative to the first fixing member 100 and the base 10, and the user can leave the lift chair easily.

Since the seat 30 moves upward relative to the base 10 before it rotates, the feet of the user are substantially straight when he leaves the lift chair. Therefore, the force on the knees and the calves of the human can be reduced. For example, the rotation angle of the seat 30 can be 15 degrees-45 degrees.

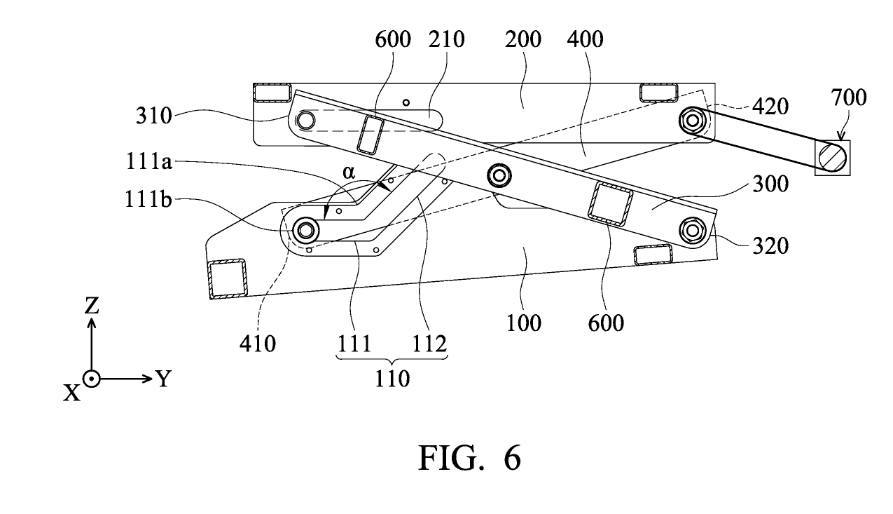

Referring to FIG. 6, in another embodiment, the driving mechanism 20 further comprises a second motor 700. The second motor 700 is connected to the second fixing member 200 and can provide force to rotate the second fixing member 200.

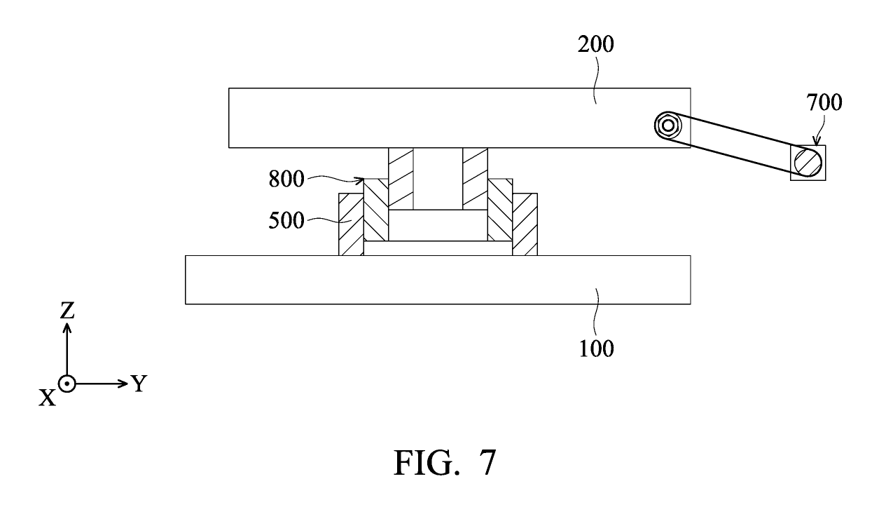

Referring to FIG. 7, in another embodiment, the driving mechanism 20 comprises a first fixing member 100, a second fixing member 200, a first motor 500, and a second motor 700, and a telescopic rod 800. The first fixing member 100 is affixed to the base 10. The second fixing member 200 is affixed to the seat 30. The first motor 500 is disposed on the first fixing member 100, and the telescopic rod 800 is connected to the first motor 500 and the second fixing member 200. The telescopic rod 800 can be driven by the first motor 500 to lengthen and shorten, and the second fixing member 200 can be moved relative to the first fixing member 100 by the telescopic rod 800. The second motor 700 is connected to the second fixing member 200 and can provide force to rotate the second fixing member 200.

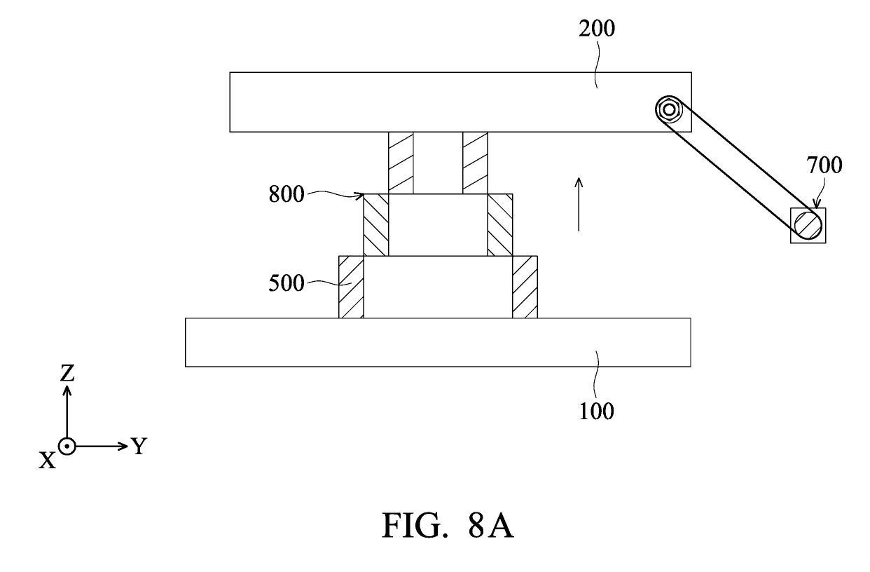

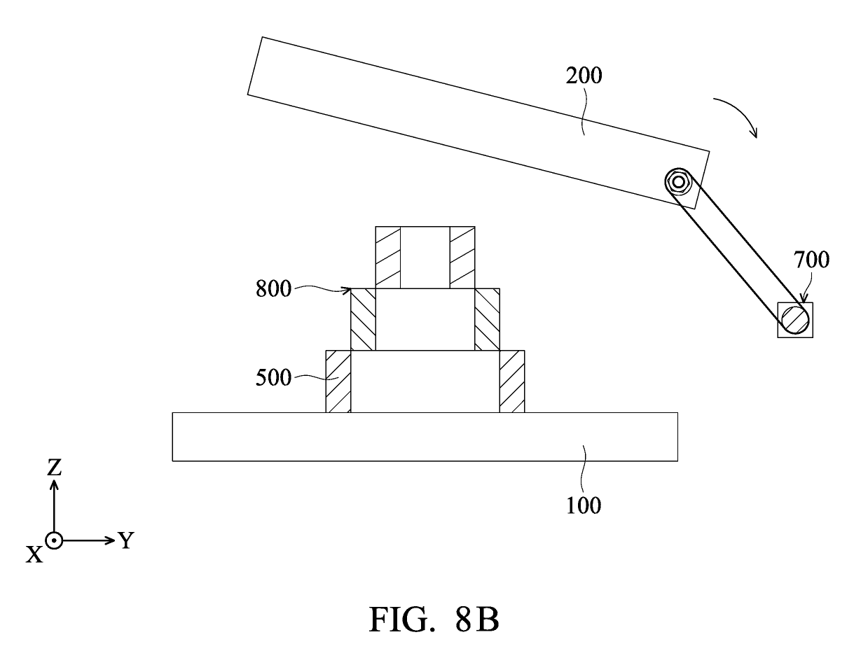

When the user on the seat 30 wants to leave lift chair, the lift chair can assist the user to stand up. As shown in FIGS. 8A, first, the first motor 500 can drive the telescopic rod 800 to lengthen, and the second fixing member 200 can be moved. Therefore, the seat 30 can move upwardly from a first position to a second position. For example, the distance between the first position and the second position can be 5 cm-10 cm.

When the seat 30 moves from the first position to the second position, the top surface of the seat 30 remains horizontal.

Subsequently, referring to FIG. 8B, the second motor 700 can drive the second fixing member 200 to rotate relative to the base 10, and the user can leave the lift chair easily. For example, the rotation angle of the seat 30 can be 15 degrees-45 degrees.

In summary, a lift chair and a module for lifting the seat of the lift chair are provided in the invention. Since the seat moves upwardly relative to the base before it rotates, the feet of the user is substantially in a straight condition when he leaves the lift chair. Therefore, the force on the knees and the calves of the human can be reduced, and the user can leave the lift chair easily.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A lift chair, comprising:
a base;
a seat; and
a driving mechanism, connected to the base and the seat, wherein the driving mechanism can drive the seat to move relative to the base between a first position and a second position, wherein when the seat is in the first position, a first distance is formed between the seat and the base, and when the seat is in the second position, a second distance exceeding the first distance is formed between the seat and the base, wherein when the seat is in the second position, the driving mechanism can drive the seat to rotate relative to the base.

2. The lift chair as claimed in claim 1, wherein during the movement of the seat between the first position and the second position, the top surface of the seat remains horizontal.

3. The lift chair as claimed in claim 1, wherein the seat is in the first position, a height is formed between the top surface of the seat and a bottom of the base, wherein the distance between the first position and the second position is ⅕-⅙ of the height.

4. The lift chair as claimed in claim 3, wherein the distance between the first position and the second position is 5 cm-10 cm.

5. The lift chair as claimed in claim 1, wherein the driving mechanism comprises:
a first fixing member, affixed to the base;
a first guiding slot, formed on the first fixing member;
a second fixing member, affixed to the seat;
a second guiding slot, formed on the second fixing member;
a first rod, connected to the first fixing member and the second fixing member, wherein one end of the first rod is slidably disposed in the second guiding slot, and another end of the first rod is pivotally connected to the first fixing member; and
a second rod, connected to the first fixing member and the second fixing member, wherein one end of the second rod is slidably disposed in the first guiding slot, and another end of the second rod is pivotally connected to the second fixing member.

6. The lift chair as claimed in claim 5, wherein the first rod and the second rod form an X-shaped structure.

7. The lift chair as claimed in claim 5, wherein the second guiding slot has a longitudinal structure, and the first guiding slot has a parallel portion and an inclined portion, wherein an obtuse angle is formed between the parallel portion and the inclined portion.

8. The lift chair as claimed in claim 7, wherein the distance between the second fixing member and the inclined portion is less than the distance between the second fixing member and the parallel portion.

9. The lift chair as claimed in claim 7, wherein the parallel portion has a first side communicated with the inclined portion and a second side opposite to the first side, wherein when the end of the second rod is situated at the second side, the seat is in the first portion, wherein when the end of the second rod is situated at the first side, the seat is in the second position.

10. The lift chair as claimed in claim 7, wherein when the end of the second rod slides along the inclined portion, the seat rotates relative to the base.

11. The lift chair as claimed in claim 5, wherein the first rod is pivotally connected to the second rod.

12. The lift chair as claimed in claim 5, wherein the driving mechanism further comprises a first motor connected to the first rod and the second rod.

13. The lift chair as claimed in claim 12, wherein the driving mechanism further comprises a second motor connected to the second fixing member.

14. The lift chair as claimed in claim 1, wherein the driving mechanism comprises:
a first fixing member, affixed to the base;
a second fixing member, affixed to the seat;
a first motor;
a telescopic rod, connected to the first motor and the second fixing member; and
a second motor, connected to the second fixing member.

15. A method for lifting a seat of a lift chair, comprising:
moving the seat from a first position to a second position, wherein when the seat is in the first position, a first distance is formed between the seat and the base, and when the seat is in the second position, a second distance exceeding the first distance is formed between the seat and the base; and
rotating the seat relative to the base when the seat is in the second position.

16. The method as claimed in claim 15, wherein when the seat moves from the first position to the second position, the top surface of the seat remains horizontal.

17. The method as claimed in claim 15, wherein when the seat is in the first position, a height is formed between the top surface of the seat and a bottom of the base, wherein the distance between the first position and the second position is ⅕-⅙ of the height.

18. The method as claimed in claim 15, wherein the distance between the first position and the second position is 5 cm-10 cm.

19. The method as claimed in claim 15, wherein the rotation angle of the seat is 15 degrees-45 degrees.
